(19) United States
(12) Patent Application Publication
(10) Pub. No.: US 2019/0080259 A1
(43) Pub. Date: Mar. 14, 2019

(54) METHOD OF LEARNING ROBUST REGRESSION MODELS FROM LIMITED TRAINING DATA

(71) Applicant: General Electric Company, Schenectady, NY (US)

(72) Inventors: Tianyi WANG, Niskayuna, NY (US); Fei HUANG, San Ramon, CA (US)

(21) Appl. No.: 15/703,189

(22) Filed: Sep. 13, 2017

(51) Int. Cl. G06N 99/00; G06N 5/02

(52) U.S. Cl. CPC G06N 99/005; G06N 5/022

(57) ABSTRACT

According to some embodiments, system and methods are provided, comprising building a first model structure for a reference domain; generating a first learned model for the first model structure using one or more data points associated with the reference domain; executing the first learned model with one or more data points in a target domain to predict a dependent variable associated with the target domain; calculating a residual variable for the predicted dependent variable associated with the target domain; building a second model structure for the target domain using the residual variable as a dependent variable; generating a second learned model for the second model structure using one or more data points associated with the target domain; and constructing a target model for the target domain, wherein the target model is the sum of the first and the second learned models. Numerous other aspects are provided.

### BACKGROUND

Industrial equipment or assets, generally, are engineered to perform particular tasks as part of industrial processes. For example, industrial assets can include, among other things and without limitation, manufacturing equipment on a production line, aircraft engines, wind turbines that generate electricity on a wind farm, power plants, locomotives, healthcare or imaging devices (e.g., X-ray or MRI systems) for use in patient care facilities, or drilling equipment for use in mining operations. The design and implementation of these assets often takes into account both the physics of the task at hand, as well as the environment in which such assets are configured to operate and the specific operating control these systems are assigned to.

Assets, including the asset components, typically acquire damage during assigned operations. Industries typically try to predict a cost or other value associated with each asset that goes into a shop for repair or maintenance. Typically, predictions are based on historical data associated with the asset.

It would be desirable to provide systems and methods to improve predictions associated with of an industrial asset.

### BRIEF DESCRIPTION

According to some embodiments, a method includes building a first model structure for a reference domain; generating a first learned model for the first model structure using one or more data points associated with the reference domain; executing the first learned model with one or more data points in a target domain to predict a dependent variable associated with the target domain; calculating a residual variable for the predicted dependent variable associated with the target domain; building a second model structure for the target domain using the residual variable as a dependent variable; generating a second learned model for the second model structure using one or more data points associated with the target domain; and constructing a target model for the target domain, wherein the target model is the sum of the first and the second learned models.

According to some embodiments, a system includes a target data module; a memory storying processor-executable process steps; and a target data processor coupled to the memory, and in communication with the target data module and operative to execute the processor-executable steps to cause the system to: build a first model structure for a reference domain; generate a first learned model for the first model structure using one or more data points associated with the reference domain; execute the first learned model with one or more data points in a target domain to predict a dependent variable associated with the target domain; calculate a residual variable for the predicted dependent variable associated with the target domain; build a second model structure for the target domain using the residual variable as a dependent variable; generate a second learned model for the second model structure using one or more data points associated with the target domain; and construct a target model for the target domain, wherein the target model is the sum of the first and the second learned models.

According to some embodiments, a non-transitory, computer-readable medium storing instructions that, when executed by a computer processor, cause the computer processor to build a first model structure for a reference domain; generate a first learned model for the first model structure using one or more data points associated with the reference domain; execute the first learned model with one or more data points in a target domain to predict a dependent variable associated with the target domain; calculate a residual variable for the predicted dependent variable associated with the target domain; build a second model structure for the target domain using the residual variable as a dependent variable; generate a second learned model for the second model structure using one or more data points associated with the target domain; and construct a target model for the target domain, wherein the target model is the sum of the first and the second learned models.

A technical effect of some embodiments of the invention is an improved and/or computerized technique and system for predicting service costs associated with an asset when limited historical data for the particular asset is available. Embodiments provide for the building of robust service cost models for these assets by leveraging at least one of data, models, and knowledge from historical data associated with other, assets having more data.

Embodiments provide benefits including the construction of robust predictive models for a product (e.g., asset) with a limited amount of data for the particular product. Embodiments provide a powerful method to predict values (e.g., via regression analysis) with a small sample size for an asset. Embodiments may work with arbitrary regression models, linear or nonlinear, without the need to make assumptions on the distributions of the model coefficients (unlike Bayesian regression methods that do make assumptions on the distributions). In one or more embodiments, the prediction output of the model may be used as input to systems associated with the product(s) and/or to make decisions associated with the product (e.g., when to take an asset out of service for repairs; to forecast the power output of a power plant; to predict a cost for service, etc.). With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a system according to some embodiments.

FIG. 2 illustrates a flow diagram according to some embodiments.

FIG. 3 illustrates a block diagram of a system according to some embodiments.

FIG. 4 illustrates a block diagram according to some embodiments.

### DETAILED DESCRIPTION

Statistical models may often be used to perform predictive analysis about an asset, such as performance assessment and prediction, remaining life prediction, service cost prediction, total ownership cost prediction, etc. Statistical models may often be built from collected data (i.e. historical data) about the particular asset, and therefore, the more available data, the greater the ability to build a model with strong predictive power. However, there are instances where limited historical data is available for a particular asset (e.g., a new product line, a small product line, modeling rare events, a product line with highly variable configurations—making data pooling difficult). Limited data may make it difficult to construct a reliable model, and such a model may lead to large prediction uncertainty.

Conventionally, the limited data scenario may be addressed using, for example, data pooling or a Bayesian regression approach. With data pooling, data from a similar domain (e.g., similar assets with same set of parameters) may be added to the limited data to create a larger data set with which to build a single predictive model. The inventors note that in order to pool data from different domains together, there are strict requirements on their similarity levels, which may limit its application in many real-world scenarios. On the other hand, the Bayesian regression approaches require many assumptions about the distribution of the coefficients, which may make the approach complicated and difficult to maintain with software.

In one or more embodiments, a target domain may include limited data. A target data module may then receive data from a reference domain. The reference domain may include abundant data and may behave similarly to the target domain. For example, the target domain data and the reference domain data may contain equivalent dependent variables and independent variables. A model (“reference model”) using the reference domain data may be generated.

In one or more embodiments, the model may be a regression model about a certain continuous-value dependent variable y as a function of many other independent variables x:

y=ƒ(x)

As a non-exhaustive example, a degradation condition of an aircraft engine is predicted. In one or more embodiments, for this example, the compressor efficiency of the engine may be specified as the dependent variable y, and parameters such as air temperature, altitude, fan speed, engine discharge temperature, thrust setting, etc., may be selected as the independent variables x to build the regression model. Other suitable parameters may be used.

As another non-exhaustive example, the performance of a power plant is forecasted. In one or more embodiments, for this example, the power generation output of the plant may be specified as the dependent variable y, and parameters such as ambient temperature, humidity, air pressure, etc., may be selected as the independent variables x to build the regression model. Other suitable parameters may be used.

As yet another non-exhaustive example, the service cost of an aircraft engine under service contract is predicted. In one or more embodiments, the total cost for each service event is specified as dependent variable y, and parameters such as hours of operation, number of flight cycles, statistics on sensor reading about engine performance, statistics on environmental parameters of airport and flight route, etc., may be selected as the independent variables x to build the regression model. Other suitable parameters may be used.

As still another non-exhaustive example, the cost incurred at a service (shop visit) event may be the dependent variable y, and parameters such as engine time since last visit, engine cycle since last visit, shop visit count, statistics of remote diagnostic variables (e.g., thrust,); environmental parameters of airport or flight route (e.g., ambient temperature, humidity, air conditions, etc.); service context (e.g., shop name, contract name, airline name, aircraft info., etc.); and work scope categorizations may be selected as the independent variables x to build the regression model. Other suitable parameters may be used. While the following non-exhaustive examples described herein may be related to aviation assets, embodiments may apply to any suitable asset. One or more embodiments may be described with respect to a regression model with continuous-value dependent variable(s). Additionally, while the dependent variable described in the non-exhaustive examples may be related to cost, any suitable dependent variable may be used in the model(s) (e.g., efficiency of asset; power generation output; etc.).

In one or more embodiments, after the reference model structure is specified for an identified reference domain, the model coefficients may be fitted to the data in the reference domain to generate a “learned model.” As used herein, a “learned model” is a model structure with determined coefficients. The process to determine the coefficients from data may be called “fit the model to the data” or “learn the model from the data.” The learned model may then be applied by the target data module to make predictions of the dependent variable from the independent variables in the target domain, and as described further below, to help build an improved new model that may better predict the dependent variable from independent variables in the target domain.

Some embodiments relate to digital twin modeling. “Digital twin” state estimation modeling of industrial apparatus and/or other mechanically operational entities may estimate an optimal operating condition, remaining useful life, operating performance such as heat rate or other metric, of a twinned physical system using sensors, communications, modeling, history and computation. It may provide an answer in a time frame that is useful, that is, meaningfully priori to a projected occurrence of a failure event or suboptimal operation. The information may be provided by a “digital twin” of a twinned physical system. The digital twin may be a computer model that virtually represents the state of an installed product. The digital twin may include a code object with parameters and dimensions of its physical twin's parameters and dimensions that provide measured values, and keeps the values of those parameters and dimensions current by receiving and updating values via outputs from sensors embedded in the physical twin. The digital twin may have respective virtual components that correspond to essentially all physical and operational components of the installed product and combinations of products or assets that comprise an operation.

As used herein, references to a “digital twin” should be understood to represent one example of a number of different types of modeling that may be performed in accordance with teachings of this disclosure.

The term “installed product” should be understood to include any sort of mechanically operational entity, including, but not limited to, jet engines, locomotives, gas turbines, medical equipment and wind farms and their auxiliary systems as incorporated. The term is most usefully applied to large complex systems with many moving parts, numerous sensors and controls installed in the system. The term “installed” includes integration into physical operations such as the use of engines in an aircraft fleet whose operations are dynamically controlled, a locomotive in connection with railroad operations, or apparatus construction in, or as part of, an operating plant building, machines in a factory or supply chain and etc.

As used herein, the term “automatically” may refer to, for example, actions that may be performed with little or no human interaction.

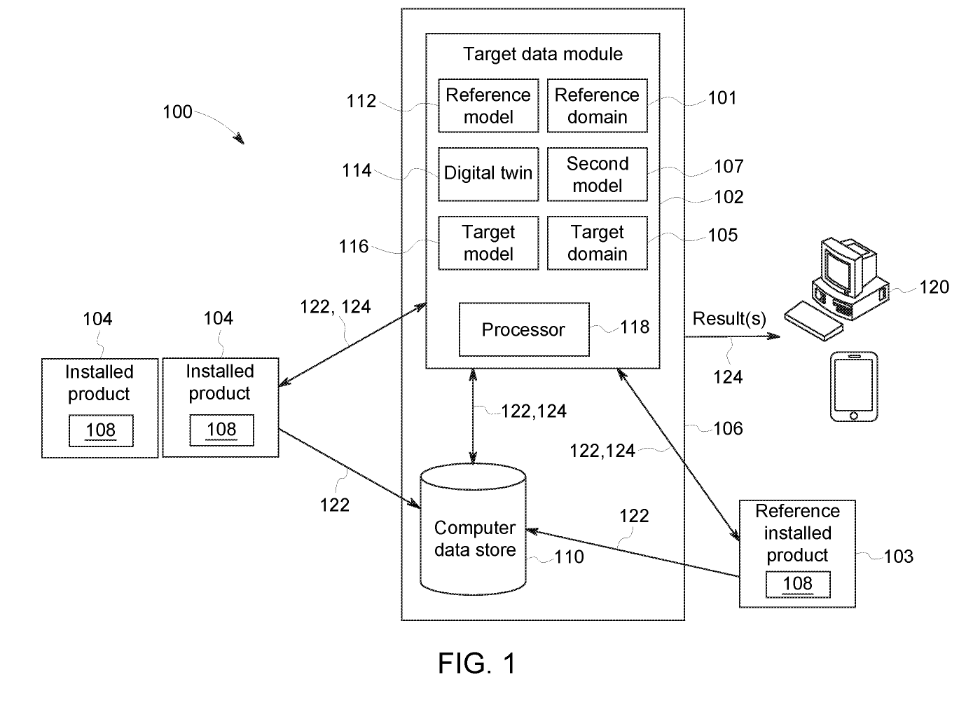

Turning to FIG. 1, is a block diagram of an example operating environment or system 100 in which a target data module 102 may be implemented, arranged in accordance with at least one embodiment described herein. FIG. 1 represents a logical architecture for describing processes according to some embodiments, and actual implementations may include more or different components arranged in other manners.

The system 100 may include at least one “installed product” 103, 104. While three installed products 103, 104 are shown herein to represent a fleet of installed products, any suitable number may be used. It is noted that each installed product 103, 104 communicates with a platform106, and elements thereof, in a same manner, as described below. As noted above, the installed product 103, 104 may be, in various embodiments, a complex mechanical entity such as the production line of a factory, a gas-fired electrical generating plant, a jet engine on an aircraft amongst a fleet (e.g., two or more aircrafts or other assets), a wind farm, a locomotive, etc. As used herein, the terms “installed product” and “asset” may be used interchangeably. The installed product 103, 104 may include a considerable (or even very large) number of physical elements or components 108, which for example may include turbine blades, fasteners, rotors, bearings, support members, housings, etc. As used herein, the terms “physical element” and “component” may be used interchangeably. The installed product 103, 104 may also include subsystems, such as sensing and localized control, in one or more embodiments.

In some embodiments, the platform 106 may include a computer data store 110 that may provide information to the target data module 102 and store results from the target data module 102. The target data module 102 may include a reference domain 101, a target domain 105, a reference model 112, a digital twin 114, a target model 116 and one or more processing elements 118.

The processor 118 may, for example, be a conventional microprocessor, and may operate to control the overall functioning of the target data module 102. In one or more embodiments, the processor 118 may be programmed with a continuous or logistical model of industrial processes that use the one or more installed products 103, 104.

In one or more embodiments, the computer data store 110 may comprise any combination of one or more of a hard disk drive, RAM (random access memory), ROM (read only memory), flash memory, etc. The computer data store 110 may store software that programs the processor 118 and the target data module 102 to perform functionality as described herein.

The computer data store 110 may support multi-tenancy to separately support multiple unrelated clients by providing multiple logical database systems which are programmatically isolated from one another.

The data stored in computer data store 110 may be received from disparate hardware and software systems associated with the installed product 103, 104, or otherwise, some of which may not be inter-operational with one another. The systems may comprise a back-end data environment employed in a business, industrial, or personal context. The data may be pushed to computer data store 110 and/or provided in response to queries received therefrom.

The data may be included in a relational database, a multi-dimensional database, an eXtendable Markup Language (XML) document, and/or any other structured data storage system. The physical tables of computer data store 110 may be distributed among several relational databases, multi-dimensional databases, and/or other data sources. The data of data store 110 may be indexed and/or selectively replicated in an index.

The computer data store 110 may implement an “in-memory” database, in which volatile (e.g., non-disk-based) storage (e.g., Random Access Memory) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, and object-based data.

The target data module 102, according to some embodiments, may access the computer data store 110 and utilize the processing elements 118 to generate the reference model 112, in some instances, and to generate the target model 116 that may be transmitted to (and in some instances presented on) at least one of various user platforms 120 or to other systems (not shown), as appropriate (e.g., for display to, and manipulation by, a user). In one or more embodiments, the results of the target model 116 may be used to operate the installed product, operate another system, or be input to another system.

A communication channel 122 may be included in the system 100 to supply data from at least one of the installed product 103, 104 and the computer data store 110 to the target data module 102.

In some embodiments, the system 100 may also include a communication channel 124 to supply output from the target data module 102 to at least one of user platforms 120, or to other systems. In some embodiments, signals received by the user platform 120, may cause modification in the state or condition or another attribute of the installed product 103, 104.

As used herein, devices, including those associated with the system 100 and any other devices described herein, may exchange information and transfer data (“communication”) via any number of different systems, including one or more wide area networks (WANs) and/or local area networks (LANs) that enable devices in the system to communicate with each other. In some embodiments, communication may be via the Internet, including a global internetwork formed by logical and physical connections between multiple WANs and/or LANs. Alternately, or additionally, communication may be via one or more telephone networks, cellular networks, a fiber-optic network, a satellite network, an infrared network, a radio frequency network, any other type of network that may be used to transmit information between devices, and/or one or more wired and/or wireless networks such as, but not limited to Bluetooth access points, wireless access points, IP-based networks, or the like. Communication may also be via servers that enable one type of network to interface with another type of network. Moreover, communication between any of the depicted devices may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

A user may access the system 100 via one of the user platforms 120 (a control system, a desktop computer, a laptop computer, a personal digital assistant, a tablet, a smartphone, etc.) to access the target data module 102 and information about and/or manage the installed product 103, 104 in accordance with any of the embodiments described herein. According to one or more embodiments, the system 100 may execute program code of a software application for presenting interactive graphical user display interfaces to allow interaction with the target data module 102.

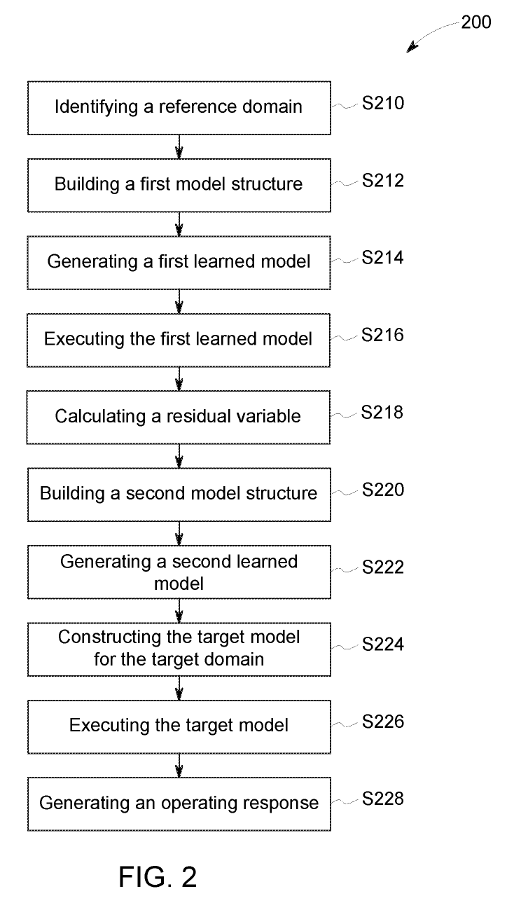

Turning to FIG. 2, a flow diagram of an example of operation according to some embodiments is provided. In particular, FIG. 2 provides a flow diagram of a process 200, according to some embodiments. Process 200, and any other process described herein, may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 100 is conditioned to perform the process 200 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow chart(s) described herein do not imply a fixed order to the steps, and embodiments of the present invention may be practiced in any order that is practicable.

Initially at S210, a reference domain (R) 101 (FIG. 1) is identified for association with a target domain (T) 105 (FIG. 1). In one or more embodiments, the reference domain includes parameter data for a reference installed product 103. The reference installed product 103 may be different in at least one aspect from the target installed product 104. In one or more embodiments, the reference installed product 103 may be similar enough to the target installed product 104 such that there is a domain understanding between the products (e.g., between the reference domain 101 and the target domain (T) 105), such that the reference domain 101 may behave similarly to the target domain 105. For example, the products may be different product lines, but may have the same associated parameters or variables, or at least one or more common associated parameters.

As a non-exhaustive example, a project may be tasked with reviewing and updating a contract service cost prediction for aircraft engines. In one or more embodiments, the service cost model may be a regression model about the service cost as a function of many other parameters:

y=ƒ(x)

where y is the cost incurred at a service (shop visit) event and x's are the parameters described above.

As described above, the target domain data (y_{T}, X_{T}) and the reference domain data (yR, XR) may contain at least one equivalent response/dependent variable (y) having continuous values, and independent variable (X), wherein the reference dependent variable is represented herein by y_{R} and the target dependent variable is represented herein by y_{T}. The inventors note that “reference dependent variable” and “reference independent variable” may be used herein to refer to values in a reference domain associated with a dependent and independent variable, respectively. Similarly, the “target dependent variable” and “target independent variable” may be used herein to refer to values in a target domain associated with a dependent and independent variable, respectively. In one or more embodiments, the reference independent variables (X_{R}) may contain at least one same variable as the target independent variables (X_{T}). The reference domain 101 may behave similarly to the target domain 105 in terms of X and y relations.

Continuing with the example, the aviation group may have a product line, Product B (target) that they would like to generate service cost predictions for. However, Product B does not have much historical data in the target domain 105. The limited historical data may be due to at least one of: the size of the product line, the age of the product line (e.g., a new product line), modeling rare events, a product line with highly variable configurations (which may make data pooling difficult) for example. In contrast, the aviation group may also have Product A (reference), which may be a mature product line and may include more historical data in the reference domain 101 than Product B. It is noted that the amount of data needed may be to build a certain model with acceptable prediction uncertainty that may be deployed in production. “Not enough” data may indicate the model built from this data may be too uncertain to be deployed. Product A and Product B may both be engines, for example, and be associated with at least one common parameter. As used herein, the terms “parameter” and “variable” may be used interchangeably. For example, the independent variable (X) may be engine cycle since last visit.

Turning back to the process 200, in S212 a reference model (MR) structure may be built, where the model is M_{R}: X_{R}→y_{R}. The inventors note that the reference domain 101 may include enough data (y_{R}, X_{R}) to build a reliable reference model (M_{R}) from a predictive standpoint. In one or more embodiments, the reference model (M_{R}) 112 is a regression model. In one or more embodiments, the regression model may be a linear model, a generalized linear model or a nonlinear model.

Then, in S214, a learned reference model is generated. In one or more embodiments, the learned reference model is generated for the reference model structure using one or more data points associated with the reference domain. In one or more embodiments, for example, the reference model (M_{R}) may be fitted to the data in the reference domain 101, y=M_{R}(X), to determine coefficients for each parameter in the reference model 112. In one or more embodiments, the model parameters may be fitted using methods including, but not limited to, Ordinal Least Square, Maximum Likelihood, and Gradient Descent, with or without regularization on the model coefficients. As used herein, a “learned reference model” is a model structure with determined coefficients. The process to determine the coefficients from data may be called “fit the model to the data” or “learn the model from the data.”

A dependent variable y_{T} is predicted in S216. In one or more embodiments, the learned reference model is executed with one or more data points in the target domain to predict a dependent variable associated with the target domain. As used herein, the predicted dependent variable y_{T} may be noted as M_{R}(X_{T}). In one or more embodiments, the target domain 105 includes at least one data point (y_{T}, X_{T}). In one or more embodiments, the target domain may include one or more target data points, each target data point including a same dependent variable and independent variables as in reference data points in the reference domain. In one or more embodiments, the learned reference model structure may model a same dependent variable from the reference domain as the predicted dependent variable from the target domain. In one or more embodiments, the dependent variable from the target domain and the dependent variable from the reference domain have continuous values.

A new (e.g., residual) variable (z_{T}) is calculated in S218 using the predicted variable M_{R}(X_{T}). In one or more embodiments, after the residual variable is calculated, the residual variable may be part of the data in the target domain. The residual variable (z_{T}) is the calculated difference between the predicted y, determined in S216 and the “true” y from the target domain 105.

z_{T}=y_{T}−M_{R}(X_{T})

Using the residual variable (z_{T}) as a dependent variable and target independent variables from the target domain (X_{T}), a second model 107 structure (z=M_{TR}(X)) is built for the target domain in S220. In one or more embodiments, the second model 107 may be a regularized regression model. In one or more embodiments, the second model 107 structure (e.g., function form) may include all, or a subset, of the independent variables used in the reference model M_{R}, and eventually, as described below, certain coefficients related to those variables will be decided using data in the target domain 105. In one or more embodiments, the second model structure 107 may use the same or different model structure (function form) from the reference model M_{R}. Of note, even if the structure is the same, the coefficients will be different, as described below, because they are determined using different data (e.g., data from the target domain).

In one or more embodiments, regularization may be applied to the second model (M_{TR}), resulting in a regularized second model 109. Regularization may be used to solve an ill-posed problem (e.g., with just a few points, linear regression may not be stable, and a unique solution may not be found) or to prevent overfitting by introducing additional constraints to the original problem. For example, a linear model with the following form

y=x^{T}b+ϵ

where b=(b₁, b₂, . . . , bₚ)^{T}, can be solved by the Ordinary Least Square (OLS) method, which optimizes the following non-regularized loss function

min Σᵢ₌₁ⁿ(xᵢ^{T}b−yᵢ)²

where n is the number of data points in the data set and i is the index of the data points

A regularized linear model with L2 norm on the coefficients (“Ridge Regression”) optimizes the following loss function, which includes an additional regularization term on the coefficients b

min(Σᵢ₌₁ⁿ(xᵢ^{T}b−yᵢ)²+λ∥b∥₂²)

where ∥b∥₂²=Σⱼ₌₁^{p}bⱼ² and p is the number of coefficients in the model.

For a generic regression problem

y=ƒ(x, b)+ϵ

the regularized loss function with L2-norm on the coefficients has the following form:

min(Σᵢ₌₁ⁿ(ƒ(xᵢ, b)−yᵢ)²+λ∥b∥₂²)

Other suitable regularization methods besides Ridge Regression may be used (e.g., L1-norm, L1 norm plus L2 norm, etc.) to define the loss function.

Then in S222, a second learned model for the second model structure is generated using one or more data points associated with the target domain, where the data points include the calculated residual values zₜ from S218. In one or more embodiments, for example, the regularized second model (M_{RT}) 109 may be fitted to the data (zₜ, X_{T}) from the target domain to determine new coefficients.

The inventors note that the use of a regularized regression model in S222 may reduce the prediction uncertainty of the model when the target domain 105 (e.g., sample size) is relatively small compared to the number of independent coefficients in the model.

Using the new coefficients from S222, a model (M_{T}(x)) 116 for the target domain 105 (“target model”) is constructed in S224 from the sum of the first and second learned models. For example,

M_{T}(x)=M_{R}(X)+M_{RT}(X)

may be used to make predictions for a given X_{T} in the target domain 105. Then in S226, the target model 116 is executed with one or more new data points of the independent target variables (i.e. non-historical) to generate new predicted values for the dependent variable.

The inventors note that the calculation of the residual variable (z_{T}) in S218 and the construction of the second model M_{TR} 109 on the residual variables (z_{T}) in S220 may allow the reference model structure M_{R} from S212 to be used as prior knowledge in the target model 116 for the target domain 105.

In some embodiments, the predictions for the given X_{T} in the target domain 105 may be used to generate an operating response in S228. As described above, for example, the predictions for the given X_{T} may be used to manage operations of the installed product 104 (e.g., the prediction may be returned to the installed product or transmitted to another system for managing operations of the installed product). For example, for a given engine discharge temperature, the target data module 102 may predict the cost of a shop visit to be more than for a different engine discharge temperature, and based on that prediction, the engine may be operated at a different capacity or may be operated at an unchanged capacity.

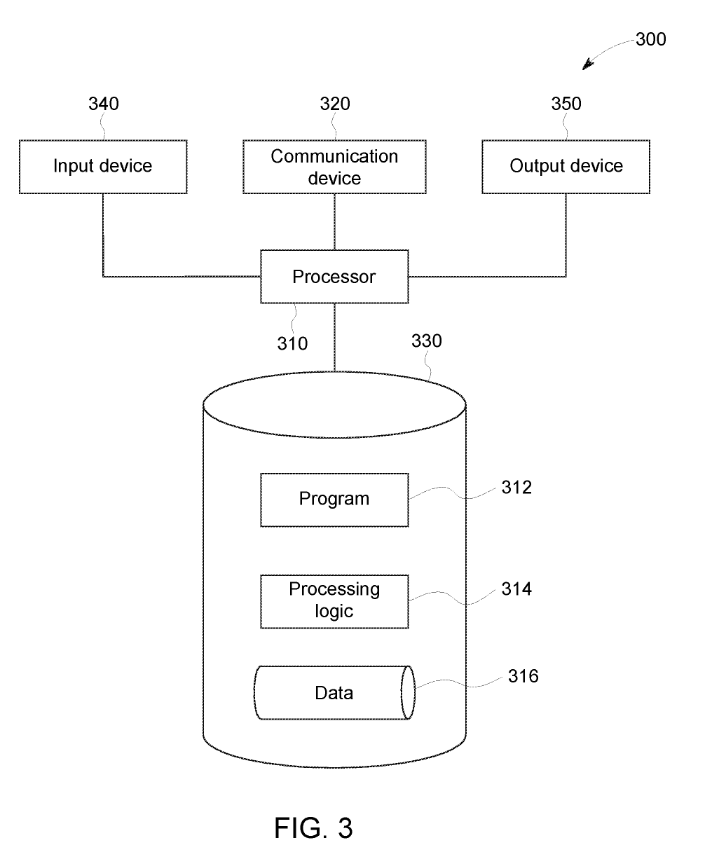

Note the embodiments described herein may be implemented using any number of different hardware configurations. For example, FIG. 3 illustrates a target data platform 300 that may be, for example, associated with the system 100 of FIG. 1. The target data platform 300 comprises a target data processor 310 (“processor”), such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more users. The target data platform 300 further includes an input device 340 (e.g., a mouse and/or keyboard to enter information) and an output device 350 (e.g., to output and display the visualization/manipulations).

The processor 310 also communicates with a memory/storage device 330. The storage device 330 may comprise any appropriate information storage device, including combinations of magnetic storage devices (e.g., a hard disk drive), optical storage devices, mobile telephones, and/or semiconductor memory devices. The storage device 330 may store a program 312 and/or target data processing logic 314 for controlling the processor 310. The processor 310 performs instructions of the programs 312, 314, and thereby operates in accordance with any of the embodiments described herein. For example, the processor 310 may receive data and then may apply the instructions of the programs 312, 314 to predict a value for a dependent variable in a domain with limited data.

The programs 312, 314 may be stored in a compressed, uncompiled and/or encrypted format. The programs 312, 314 may furthermore include other program elements, such as an operating system, a database management system, and/or device drivers used by the processor 310 to interface with peripheral devices.

As used herein, information may be “received” by or “transmitted” to, for example: (i) the platform 300 from another device; or (ii) a software application or module within the platform 300 from another software application, module, or any other source.

It is noted that while progress with industrial equipment automation has been made over the last several decades, and assets have become ‘smarter,’ the intelligence of any individual asset pales in comparison to intelligence that can be gained when multiple smart devices are connected together. Aggregating data collected from or about multiple assets may enable users to improve business processes, for example by improving effectiveness of asset maintenance or improving operational performance, if appropriate. Industrial-specific data collection and modeling technology may be developed and applied.

In an example, an industrial asset may be outfitted with one or more sensors configured to monitor respective ones of an asset's operations or conditions. Data from the one or more sensors may be recorded or transmitted to a cloud-based or other remote computing environment. By bringing such data into a cloud-based computing environment, new software applications informed by industrial process, tools and know-how may be constructed, and new physics-based analytics specific to an industrial environment may be created. Insights gained through analysis of such data may lead to enhanced asset designs, or to enhanced software algorithms for operating the same or similar asset at its edge, that is, at the extremes of its expected or available operating conditions.

The systems and methods for managing industrial assets may include or may be a portion of an Industrial Internet of Things (IIoT). In an example, an IIoT connects industrial assets, such as turbines, jet engines, and locomotives, to the Internet or cloud, or to each other in some meaningful way. The systems and methods described herein may include using a “cloud” or remote or distributed computing resource or service. The cloud may be used to receive, relay, transmit, store, analyze, or otherwise process information for or about one or more industrial assets. In an example, a cloud computing system may include at least one processor circuit, at least one database, and a plurality of users or assets that may be in data communication with the cloud computing system. The cloud computing system may further include, or may be coupled with, one or more other processor circuits or modules configured to perform a specific task, such as to perform tasks related to asset maintenance, analytics, data storage, security, or some other function.

However, the integration of industrial assets with the remote computing resources to enable the IIoT often presents technical challenges separate and distinct from the specific industry and from computer networks, generally. A given industrial asset may need to be configured with novel interfaces and communication protocols to send and receive data to and from distributed computing resources. Given industrial assets may have strict requirements for cost, weight, security, performance, signal interference, and the like, such that enabling such an interface is rarely as simple as combining the industrial asset with a general purpose computing device.

To address these problems and other problems resulting from the intersection of certain industrial fields and the IIoT, embodiments may enable improved interfaces, techniques, protocols, and algorithms for facilitating communication with, and configuration of, industrial assets via remote computing platforms and frameworks. Improvements in this regard may relate to both improvements that address particular challenges related to particular industrial assets (e.g., improved aircraft engines, wind turbines, locomotives, medical imaging equipment) that address particular problems related to use of these industrial assets with these remote computing platforms and frameworks, and also improvements that address challenges related to operation of the platform itself to provide improved mechanisms for configuration, analytics, and remote management of industrial assets.

The Predix™ platform available from GE is a novel embodiment of such Asset Performance Management Platform (APM) technology enabled by state of the art cutting edge tools and cloud computing techniques that may enable incorporation of a manufacturer's asset knowledge with a set of development tools and best practices that may enable asset users to bridge gaps between software and operations to enhance capabilities, foster innovation, and ultimately provide economic value. Through the use of such a system, a manufacturer of industrial assets can be uniquely situated to leverage its understanding of industrial assets themselves, models of such assets, and industrial operations or applications of such assets, to create new value for industrial customers through asset insights.

The further advancement in sensing, control, simulation and optimization in systems such as the disclosed extends past the current art APM limitations of past operations=future operations and little ability to trade off actions in maintenance or operations in the current period for those of future periods where optimal interventions may be made such as maintenance, assignment, duty limitations, through time, having the benefit of far more accurate starting conditions afforded by the true-up.

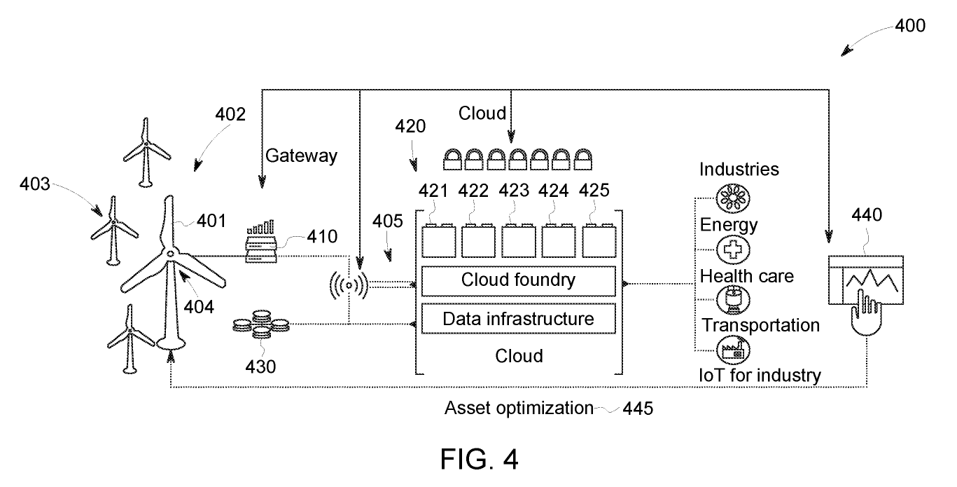

FIG. 4 illustrates generally an example of portions of a first APM 400. As further described herein, one or more portions of an APM may reside in an asset cloud computing system 420, in a local or sandboxed environment, or may be distributed across multiple locations or devices. An APM may be configured to perform any one or more of data acquisition, data analysis, or data exchange with local or remote assets, or with other task-specific processing devices.

The first APM 400 may include a first asset community 402 that may be communicatively coupled with the asset cloud computing system 420. A plurality of assets 402, 403 may be subject to state estimation at one or more multiple time intervals. Within a given industrial system, there may be estimations of state for more than one system or sub-system such as a blade of a wind turbine 401 or gear 404 associated with the turbine 401. These sub-systems may be combined to estimate the state of damage and performance for an integrated system such as, for example, a windmill, an aircraft engine, a power plant and a train. Other suitable integrated systems may be used. In an example, a machine module 410 receives information from, or senses information about, at least one asset member of the first asset community 402, and configures the received information for exchange with the asset cloud computing system 420. In an example, the machine module 410 is coupled to the asset cloud computing system 420 or to an enterprise computing system 430 via a communication gateway 405.

In an example, the communication gateway 405 includes or uses a wired or wireless communication channel that may extend at least from the machine module 410 to the asset cloud computing system 420. The asset cloud computing system 420 includes several layers. In an example, the asset cloud computing system 420 includes at least a data infrastructure layer, a cloud foundry layer, and modules for providing various functions. In the example of FIG. 4, the asset cloud computing system 420 includes an asset module 421, an analytics module 422, a data acquisition module 423, a data security module 424, and an operations module 425. Each of the modules 421-425 includes or uses a dedicated circuit, or instructions for operating a general purpose processor circuit, to perform the respective functions. In an example, the modules 421-425 are communicatively coupled in the asset cloud computing system 420 such that information from one module may be shared with another. In an example, the modules 421-425 are co-located at a designated datacenter or other facility, or the modules 421-425 can be distributed across multiple different locations.

An interface device 440 may be configured for data communication with one or more of the machine module 410, the gateway 405, or the asset cloud computing system 420. The interface device 440 may be used to monitor or control one or more assets. In an example, information about the first asset community 402 is presented to an operator at the interface device 440. The information about the first asset community 402 may include information from the machine module 410, or the information may include information from the asset cloud computing system 420. In an example, the information from the asset cloud computing system 420 may include information about the first asset community 402 in the context of multiple other similar or dissimilar assets, and the interface device 440 may include options for optimizing one or more members of the first asset community 402 based on analytics performed at the asset cloud computing system 420.

In an example, an operator selects a parameter update for the first wind turbine 401 using the interface device 440, and the parameter update is pushed to the first wind turbine via one or more of the asset cloud computing system 420, the gateway 405, and the machine module 410. In an example, the interface device 440 is in data communication with the enterprise computing system 430 and the interface device 440 provides an operation with enterprise-wide data about the first asset community 402 in the context of other business or process data. For example, choices with respect to asset optimization 445 may be presented to an operator in the context of available or forecasted raw material supplies or fuel costs. In an example, choices with respect to asset optimization 445 may be presented to an operator in the context of a process flow to identify how efficiency gains or losses at one asset may impact other assets. In an example, one or more choices described herein as being presented to a user or operator may alternatively be made automatically by a processor circuit according to earlier-specified or programmed operational parameters. In an example, the processor circuit may be located at one or more of the interface device 440, the asset cloud computing system 420, the enterprise computing system 430, or elsewhere.

Returning again to the example of FIG. 4 some capabilities of the first APM 400 are illustrated. The example of FIG. 4 includes the first asset community 402 with multiple wind turbine assets, including the first wind turbine 401. Wind turbines are used in some examples herein as non-limiting examples of a type of industrial asset that can be a part of, or in data communication with, the first AMP 400.

In an example, the multiple turbine members of the asset community 402 include assets from different manufacturers or vintages. The multiple turbine members of the asset community 402 may belong to one or more different asset communities, and the asset communities may be located locally or remotely from one another. For example, the members of the asset community 402 may be co-located on a single wind farm, or the members may be geographically distributed across multiple different farms. In an example, the multiple turbine members of the asset community 402 may be in use (or non-use) under similar or dissimilar environmental conditions, or may have one or more other common or distinguishing characteristics.

FIG. 4 further includes the device gateway 405 configured to couple the first asset community 402 to the asset cloud computing system 420. The device gateway 405 may further couple the asset cloud computing system 420 to one or more other assets or asset communities, to the enterprise computing system 430, or to one or more other devices. The first AMP 400 thus represents a scalable industrial solution that extends from a physical or virtual asset (e.g., the first wind turbine 401) to a remote asset cloud computing system 420. The asset cloud computing system 420 optionally includes a local, system, enterprise, or global computing infrastructure that can be optimized for industrial data workloads, secure data communication, and compliance with regulatory requirements.

In an example, information from an asset, about the asset, or sensed by an asset itself is communicated from the asset to the data acquisition module 424 in the asset cloud computing system 420. In an example, an external sensor may be used to sense information about a function of an asset, or to sense information about an environment condition at or near an asset. The external sensor may be configured for data communication with the device gateway 405 and the data acquisition module 424, and the asset cloud computing system 420 may be configured to use the sensor information in its analysis of one or more assets, such as using the analytics module 422.

In an example, the first AMP 400 may use the asset cloud computing system 420 to retrieve an operational model for the first wind turbine 401, such as using the asset module 421. The model may be stored locally in the asset cloud computing system 420, or the model may be stored at the enterprise computing system 430, or the model may be stored elsewhere. The asset cloud computing system 420 may use the analytics module 422 to apply information received about the first wind turbine 401 or its operating conditions (e.g., received via the device gateway 405) to or with the retrieved operational model. Using a result from the analytics module 422, the operational model may optionally be updated, such as for subsequent use in optimizing the first wind turbine 401 or one or more other assets, such as one or more assets in the same or different asset community. For example, information about the first wind turbine 401 may be analyzed at the asset cloud computing system 420 to inform selection of an operating parameter for a remotely located second wind turbine that belongs to a different second asset community.

The first AMP 400 includes a machine module 410. The machine module 410 may include a software layer configured for communication with one or more industrial assets and the asset cloud computing system 420. In an example, the machine module 410 may be configured to run an application locally at an asset, such as at the first wind turbine 401. The machine module 410 may be configured for use with, or installed on, gateways, industrial controllers, sensors, and other components. In an example, the machine module 410 includes a hardware circuit with a processor that is configured to execute software instructions to receive information about an asset, optionally process or apply the received information, and then selectively transmit the same or different information to the asset cloud computing system 420.

In an example, the asset cloud computing system 420 may include the operations module 425. The operations module 425 may include services that developers may use to build or test Industrial Internet applications, or the operations module 425 may include services to implement Industrial Internet applications, such as in coordination with one or more other AMP modules. In an example, the operations module 425 includes a microservices marketplace where developers may publish their services and/or retrieve services from third parties. The operations module 425 can include a development framework for communicating with various available services or modules. The development framework may offer developers a consistent look and feel and a contextual user experience in web or mobile applications.

In an example, an AMP may further include a connectivity module. The connectivity module may optionally be used where a direct connection to the cloud is unavailable. For example, a connectivity module may be used to enable data communication between one or more assets and the cloud using a virtual network of wired (e.g., fixed-line electrical, optical, or other) or wireless (e.g., cellular, satellite, or other) communication channels. In an example, a connectivity module forms at least a portion of the gateway 405 between the machine module 410 and the asset cloud computing system 420.

In an example, an AMP may be configured to aid in optimizing operations or preparing or executing predictive maintenance for industrial assets. An AMP may leverage multiple platform components to predict problem conditions and conduct preventative maintenance, thereby reducing unplanned downtimes in the near term or through time by intentional intervention. In an example, the machine module 410 is configured to receive or monitor data collected from one or more asset sensors and, using physics-based analytics (e.g., finite element analysis or some other technique selected in accordance with the asset being analyzed), detect error conditions based on a model of the corresponding asset. In an example, a processor circuit applies analytics or algorithms at the machine module 410 or at the asset cloud computing system 420, one embodiment having the analytic being a discrete event simulator which changes the exogenous conditions (e.g. weather) and control points, maintenance events, work-scopes and locations, runs replications and computes confidence intervals and contribution to variance over one or more time intervals. In another embodiment, the analytic being a dynamic programming modality. In another embodiment, the analytic being a Monte-Carlo modality.

In response to the detected error conditions, the AMP may issue various mitigating commands to the asset, such as via the machine module 410, for manual or automatic implementation at the asset. In an example, the AMP may provide a shut-down command to the asset in response to a detected error condition. Shutting down an asset before an error condition becomes fatal may help to mitigate potential losses or to reduce damage to the asset or its surroundings. In addition to such an edge-level application, the machine module 410 may communicate asset information to the asset cloud computing system 420.

In an example, the asset cloud computing system 420 may store or retrieve operational data for multiple similar assets. Over time, data scientists or machine learning may identify patterns and, based on the patterns, may create improved physics-based analytical models for identifying or mitigating issues at a particular asset or asset type. The improved analytics may be pushed back to all or a subset of the assets, such as via multiple respective machine modules 410, to effectively and efficiently improve performance of designated (e.g., similarly-situated) assets.

In an example, the asset cloud computing system 420 includes a Software-Defined Infrastructure (SDI) that serves as an abstraction layer above any specified hardware, such as to enable a data center to evolve over time with minimal disruption to overlying applications. The SDI enables a shared infrastructure with policy-based provisioning to facilitate dynamic automation, and enables SLA mappings to underlying infrastructure. This configuration may be useful when an application requires an underlying hardware configuration. The provisioning management and pooling of resources may be done at a granular level, thus allowing optimal resource allocation.

In a further example, the asset cloud computing system 420 is based on Cloud Foundry (CF), an open source PaaS that supports multiple developer frameworks and an ecosystem of application services. Cloud Foundry can make it faster and easier for application developers to build, test, deploy, and scale applications. Developers thus gain access to the vibrant CF ecosystem and an ever-growing library of CF services. Additionally, because it is open source, CF can be customized for IIoT workloads.

The asset cloud computing system 420 may include a data services module that may facilitate application development. For example, the data services module may enable developers to bring data into the asset cloud computing system 420 and to make such data available for various applications, such as applications that execute at the cloud, at a machine module, or at an asset or other location. In an example, the data services module may be configured to cleanse, merge, or map data before ultimately storing it in an appropriate data store, for example, at the asset cloud computing system 420. A special emphasis has been placed on time series data, as it is the data format that most sensors use.

Security may be a concern for data services that deal in data exchange between the asset cloud computing system 420 and one or more assets or other components. Some options for securing data transmissions include using Virtual Private Networks (VPN) or an SSL/TLS model. In an example, the first AMP 400 may support two-way TLS, such as between a machine module and the security module 424. In an example, two-way TLS may not be supported, and the security module 424 may treat client devices as OAuth users. For example, the security module 424 may allow enrollment of an asset (or other device) as an OAuth client and transparently use OAuth access tokens to send data to protected endpoints.

A plurality of assets 402, 403 may be subject to state estimation at one or multiple time intervals. Within a given industrial system, there may be estimations of state for more than one system or sub-system such as the blade 401 or the gear 404. These subsystems may be combined to estimate the state of damage and performance for an integrated system such as a windmill or aircraft engine or power plant or train.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors 310 (FIG. 3). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A computer implemented method comprising:
building a first model structure for a reference domain;
generating a first learned model for the first model structure using one or more data points associated with the reference domain;
executing the first learned model with one or more data points in a target domain to predict a dependent variable associated with the target domain;
calculating a residual variable for the predicted dependent variable associated with the target domain;
building a second model structure for the target domain using the residual variable as a dependent variable;
generating a second learned model for the second model structure using one or more data points associated with the target domain; and
constructing a target model for the target domain, wherein the target model is the sum of the first and the second learned models.

2. The method of claim 1, wherein the second model structure is regularized.

3. The method of claiml, wherein the first model structure models a same dependent variable from the reference domain as the predicted dependent variable from the target domain.

4. The method of claim 1, wherein calculating the residual variable further comprises: subtracting the predicted dependent variable from an actual dependent variable in the target domain

5. The method of claim 1, wherein the reference domain includes one or more reference data points, each including a dependent variable and one or more independent variables.

6. The method of claim 1, wherein the target domain includes one or more target data points, each target data point including a same dependent variable and independent variables as in one or more reference data points in the reference domain.

7. The method of claim 3, wherein the dependent variable from the target domain and the dependent variable from the reference domain have continuous values.

8. The method of claim 1, wherein the learned model is a regression model.

9. The method of claim 8, wherein the regression model is one of a linear regression model, a generalized linear model and a nonlinear model.

10. A system comprising:
a target data module;
a memory storying processor-executable process steps; and
a target data processor coupled to the memory, and in communication with the target data module and operative to execute the processor-executable steps to cause the system to:
build a first model structure for a reference domain;
generate a first learned model for the first model structure using one or more data points associated with the reference domain;
execute the first learned model with one or more data points in a target domain to predict a dependent variable associated with the target domain;
calculate a residual variable for the predicted dependent variable associated with the target domain;
build a second model structure for the target domain using the residual variable as a dependent variable;
generate a second learned model for the second model structure using one or more data points associated with the target domain; and
construct a target model for the target domain, wherein the target model is the sum of the first and the second learned models.

11. The system of claim 10, wherein the second model structure is regularized.

12. The system of claim 10, wherein the first model structure models a same dependent variable from the reference domain as the predicted dependent variable from the target domain.

13. The system of claim 10, wherein calculating the residual variable further comprises processor-executable steps to cause the system to:
subtract the predicted dependent variable from an actual dependent variable in the target domain

14. The system of claim 10, wherein the reference domain includes one or more reference data points, each including one or more independent variables and a dependent variable.

15. The system of claim 10, wherein the target domain includes one or more target data points, each target data point including a same dependent variable and independent variables as in one or more corresponding reference data points in the reference domain.

16. The system of claim 12, wherein the dependent variable from the target domain and the dependent variable from the reference domain have continuous values.

17. The system of claim 10, wherein the learned model is a regression model.

18. The system of claim 17, wherein the regression model is one of a linear regression model, a generalized linear model and a nonlinear model.

19. A non-transitory computer-readable medium storing program code, the program code executable by a computer system to cause the computer system to:
build a first model structure for a reference domain;
generate a first learned model for the first model structure using one or more data points associated with the reference domain;
execute the first learned model with one or more data points in a target domain to predict a dependent variable associated with the target domain;
calculate a residual variable for the predicted dependent variable associated with the target domain;
build a second model structure for the target domain using the residual variable as a dependent variable;
generate a second learned model for the second model structure using one or more data points associated with the target domain; and
construct a target model for the target domain, wherein the target model is the sum of the first and the second learned models.

20. The medium of claim 19, wherein the second model structure is regularized.

21. The medium of claim 19, wherein calculating the residual variable further comprises program code to cause the computer system to:
subtract the predicted dependent variable from an actual dependent variable in the target domain.

22. The medium of claim 19, wherein the learned model is a regression model.
